(19) United States
(12) Patent Application Publication
(10) Pub. No.: US 2024/0386767 A1
(43) Pub. Date: Nov. 21, 2024

(54) REFRIGERATOR AND HOME APPLIANCE

(71) Applicant: LG ELECTRONICS INC., Seoul (KR)

(72) Inventors: Yoonjung HONG, Seoul (KR); Heekyung KANG, Seoul (KR); Yongbeom MA, Seoul (KR)

(73) Assignee: LG ELECTRONICS INC., Seoul (KR)

(21) Appl. No.: 18/688,907

(22) PCT Filed: Oct. 21, 2022
(86) PCT No.: PCT/KR2022/016179

§ 371 Date: Mar. 4, 2024

(30) Foreign Application Priority Data
Oct. 21, 2021 (KR) 10-2021-0140886

(51) Int. Cl. G07C 9/30; F25D 23/02

(52) U.S. Cl. CPC G07C 9/30; F25D 23/028; F25D 2323/02

(57) ABSTRACT

A home appliance includes a cabinet having a space; a door which opens and closes the space and includes a light source; a locking device for limiting the opening and closing of the door; and a control unit which, when a locking function is activated by an operation of the locking device, determines whether a pattern for unlocking the door is properly input. The control unit controls the light source of the door so that the light source changes from a first state to a second state when it is determined that the pattern has been properly input.

### CROSS REFERENCE TO RELATED APPLICATIONS

This application is the National Phase of PCT International Application No. PCT/KR2022/016179, filed on Oct. 21, 2022, which claims priority under 35 U.S.C. 119 (a) to Patent Application No. 10-2021-0140886, filed in the Republic of Korea on Oct. 21, 2021, all of which are hereby expressly incorporated by reference into the present application.

### TECHNICAL FIELD

The present disclosure relates to a refrigerator and a home appliance.

### BACKGROUND ART

In general, a refrigerator is a home appliance for storing foods in an internal storage space, which is shield by a refrigerator door, at a low temperature by low temperature air. The refrigerator cools the inside of the storage space using cool air generated by heat-exchanging with a refrigerant that circulates a cooling cycle to store the foods in an optimum state.

Such refrigerators tend to increase more and more in size and provide multi-functions due to the trends of change of dietary life and high quality, and accordingly, refrigerators provided with various structures and convenience devices in consideration of user convenience are brought to the market.

In order to harmonize with an environment in which the refrigerator is disposed or with surrounding furniture or home appliances, technologies structures for varying an outer appearance of a door front of the refrigerator are developed, and this trend is the same throughout the home appliance.

U.S. Pat. No. 8,789,900 (Prior Art Reference 1) discloses a structure in which a decoration panel forming an outer appearance is installed on a door front of a refrigerator, and here, the outer appearance of the door front is formed according to a user's preference by detachably configuring the decoration panel.

However, the refrigerator of the Prior Art Reference 1 having this structure has a problem in that, when a user wants to change the outer appearance, the entire decoration panel needs to be removed and replaced, and it is not possible to use the decoration panel before replacement any longer.

To solve this limitation, Chinese Patent Application No. 103250018 (Prior Art Reference 2) discloses a refrigerator in which a reflective layer and a transparent panel are disposed on a door front and colored light emitting members are mounted on both side ends of the reflective layer to cause the transparent panel to glow with set color.

However, in the case of Prior Art Reference 2, not only does it fail to disclose a refrigerator door locking function, but it also fails to disclose a technology that can change the color of the door in conjunction with the locking function.

### DISCLOSURE

### Technical Problem

This embodiment provides a refrigerator and a home appliance equipped with a lock function for locking a door for opening and closing an internal space.

Alternatively or additionally, this embodiment provides a refrigerator and a home appliance that can easily select doors that require locking when the lock function is activated.

Alternatively or additionally, the present embodiment provides a refrigerator and a home appliance that can distinguish between a locked door and an unlocked door when the lock function is activated.

Alternatively or additionally, the present embodiment provides a refrigerator and a home appliance that can be unlocked by a user when the lock function is activated and can display on the door whether the lock has been unlocked.

### Technical Solution

A home appliance according to an embodiment of the present disclosure may include a cabinet having a space therein; and a door configured to open and close the space. The door may include a light source.

The home appliance may further include a locking device configured to restrict opening and closing of the door.

The home appliance may further include a controller configured to determine whether a pattern for unlocking the door is normally input (correctly input), when a lock function is activated by operating the locking device.

The controller may be configured to control the light source of the door to change the light source from a first state to a second state when the controller determines that the pattern is normally input.

The controller may be configured to operate the locking device so that the door is changed to an unlocked state, when the controller determines that the pattern is normally input.

The controller may be configured to determine whether a reference time has elapsed after the door is changed to the unlocked state. The controller may be configured to operate the locking device to change the door to a locked state when the controller determines that the reference time has elapsed.

In a state where the door is changed to the unlocked state and the door is closed, information on a remaining time until the door is changed to the locked state may be displayed on the door.

When the door is opened while the remaining time information is being displayed on the door, the remaining time information may not be displayed.

When the door is opened and then closed after the door is changed to the unlocked state, information on the remaining time until the door is changed to the locked state may be displayed on the door.

To display the remaining time information, all of the plurality of LEDs are turned on after the door is changed to the unlocked state, and as the remaining time decreases, the number of turned-on LEDs may decrease.

Alternatively, to display the remaining time information, some of the plurality of LEDs may be turned on after the door is changed to the unlocked state, and as the remaining time decreases, the number of turned on LEDs may increase.

Alternatively, in order to display the remaining time information, after the door is changed to the unlocked state, all of the plurality of LEDs are turned on to emit light at a first brightness, and as the remaining time decreases, the brightness of the light emitted from the light source may decrease or increase.

Alternatively, to display the remaining time information, some or all of the plurality of LEDs are turned on after the door is changed to the unlocked state, and as the remaining time decreases, while the number of turned-on LEDs is maintained, colors of the light emitted from the turned-on LEDs may be changed in stages.

Alternatively, in order to display the remaining time information, all of the plurality of LEDs are turned on after the door is changed to the unlocked state, and as the remaining time decreases, the color of light emitted from some LEDs is changed and as the remaining time decreases, the number of LEDs whose color of light is changed may increase.

The controller may be configured to control the light source of the door to change the light source from a first state to a third state when the controller determines that the pattern is not normally (incorrectly input) input.

The space may be partitioned into a plurality of spaces, the door may include a plurality of doors that open and close each space.

The controller may operate the locking device so that a door of the plurality of doors which is in a locked state is changed to an unlocked state when the controller determines that the pattern is normally input.

A home appliance according to another aspect may include a cabinet having a plurality of partitioned spaces therein; a plurality of doors configured to open and close each of the plurality of spaces, in which at least one door includes a lighting device; a locking device configured to restrict opening and closing of at least one door of the plurality of doors; a sensor provided on the cabinet and at least one of the plurality of doors to detect a proximity of a user; and a controller configured to control the lighting device based on the sensor.

At least one of the plurality of doors may include a light source.

The controller may control the light source of a door in a locked state among the plurality of doors to change the light source from a first state to a second state when the sensor detects that the user approaches within a reference distance.

The first state is a state in which the light source is turned off, and the light source of a door in an unlocked state among the plurality of doors may maintain the first state.

The controller may control the light source of a door in an unlocked state among the plurality of doors to change from the first state to a state different from the second state.

The controller may be configured to control the light source of each door to change to the different state when all of the plurality of doors are in an unlocked state.

In the first state and the different state, the color of light emitted from the light source may be different, the brightness thereof may be different, or the number of LEDs turned on may be different.

The controller may be configured to determine whether a pattern for unlocking the locked door is normally input. The controller may be configured to operate the locking device to change the locked door to the unlocked state when the controller determines that the pattern is normally input.

A home appliance according to another aspect may include a cabinet having a plurality of partitioned spaces therein; a plurality of doors configured to open and close each of the plurality of spaces; a locking device configured to restrict opening and closing of at least one door of the plurality of doors; and a controller configured to operate the locking device so that the at least one door are locked when a lock function for locking the at least one door is activated.

A command for activating the lock function may be capable of being input from the home appliance, or be capable of receiving through a remote device with which the home appliance is capable of communicating.

The home appliance may further include a manipulator for inputting a command for activating the locking function.

The manipulator includes a plurality of buttons, and when a first button of the plurality of buttons is pressed and two or more of the remaining buttons are pressed and then the first button is pressed again, the controller may be configured to determine that the command has been input.

The home appliance may further include a user detection sensor which is provided on the cabinet or at least one of the plurality of doors, and configured to detect the proximity of a user.

The manipulator includes a plurality of buttons, and after the first button of the plurality of buttons is pressed and the user's proximity is detected within a limited distance by a user detection sensor and after two or more of the remaining buttons of the plurality of buttons are pressed, when the first button is pressed again, the controller may be configured to determine that the command has been input. The first button may be a lock button for locking the remaining buttons.

The remaining buttons may include a temperature control button and a button for selecting a storage space.

The home appliance may further include a memory configured to store information about the types and order of the remaining buttons pressed during an input process of the command as a pattern.

In a state where the lock function is activated, when the same pattern as the pattern stored in the memory is input, the controller may be configured to operate the locking device so that the door in the locked state is changed to the unlocked state.

The door in the locked state may include a light source. The door in the unlocked state may include a light source.

The controller may be configured to control the light source of the door that has been changed to the unlocked state to change from the first state to the second state when the same pattern as the pattern stored in the memory is input.

In a state where the lock function is activated, when the first button is pressed and the first button is pressed again after the same pattern as the pattern stored in the memory is input, the lock function may be deactivated.

When the first button and the second button of the plurality of buttons are pressed, a pattern identical to the pattern stored in the memory is input, a new pattern is input, and then the first button is pressed again, the new pattern may be stored in memory.

The home appliance may further include a knock detection sensor provided on one of the plurality of doors to input a command for activating the locking function; and a memory configured to store a knock pattern detected by the knock detection sensor.

Alternatively, the home appliance may further include a knock detection sensor provided on each of two or more of the plurality of doors to input a command for activating the locking function; and a memory configured to store a pattern related to the order and number of knocks detected by the knock detection sensor of each of the two or more doors.

When the locking function is activated and a pattern identical to the pattern stored in the memory is input, the controller may operate the locking device so that the door in the locked state is changed to the unlocked state.

### Advantageous Effect

According to one embodiment, when the door lock function is activated, a person with access authority can unlock the door, thereby preventing a person without access authority from using goods or food inside the space.

According to one embodiment, there is an advantage of being able to select or change a door that needs to be locked. Additionally, when the lock function is activated, there is an advantage that setting or changing the pattern for unlocking can be performed from the home appliance or a remote device that communicates with the home appliance.

According to one embodiment, it is possible to register a pattern for unlocking using a button on an existing manipulator, so there is an advantage that an additional button or an additional structure for pattern registration is unnecessary, and there is an advantage of preventing a person without access authority from easily unlocking the locking state.

According to one embodiment, when the lock function is activated, the locked door and the unlocked door can be distinguished on the door when the user approaches, so there is an advantage that the user can easily check the locked door and the unlocked door.

According to one embodiment, when the lock function is activated, while the user unlocks the door, whether the door has been unlocked may be displayed, so there is an advantage that the user can easily check whether the lock has been normally unlocked.

### DESCRIPTION OF DRAWINGS

FIG. 1 is a front view of a refrigerator according to an embodiment of the present disclosure.

FIG. 2 is a perspective view of a refrigerator door according to an embodiment present disclosure.

FIG. 3 is a view illustrating a state where a panel assembly is separated from the refrigerator door.

FIG. 4 is a cross-sectional view taken along line 4-4 of FIG. 3.

FIG. 5 is a view illustrating the disposition of a light guide plate and a light source.

FIG. 6 is a vertical cross-sectional view illustrating a light emitting state of the panel assembly.

FIG. 7 is a block diagram illustrating a flow of a control signal of the refrigerator.

FIG. 8 is a view illustrating a state where some of a plurality of doors emit light.

FIG. 9 is a view illustrating a state where all doors in a refrigerator emit light.

FIG. 10 is a block diagram illustrating a method for activating a lock function and registering a pattern for unlocking according to the first embodiment of the present disclosure.

FIG. 11 is a block diagram illustrating a method for inactivating the lock function according to the first embodiment of the present disclosure.

FIG. 12 is a block diagram illustrating a method for activating a lock function and registering a pattern for unlocking according to a second embodiment of the present disclosure.

FIG. 13 is a block diagram illustrating a method for activating a lock function and registering a pattern for unlocking according to a third embodiment of the present disclosure.

FIG. 14 is a block diagram illustrating a method for changing pattern registration according to the first embodiment of the present disclosure.

FIG. 15 is a block diagram illustrating a method for activating a lock function and registering a pattern for unlocking according to a third embodiment of the present disclosure.

FIG. 16 is a block diagram illustrating a method for activating a lock function and registering a pattern for unlocking through a remote device according to the present disclosure.

FIG. 17 is a block diagram illustrating a method for controlling a refrigerator with an activated lock function according to an embodiment of the present disclosure.

FIG. 18 is a view illustrating the operation of a light source when a user's approach is detected while the lock function is activated.

FIG. 19 is a view illustrating the operation of a light source when a pattern is normally input.

FIG. 20 is a view illustrating the operation of a light source when a pattern is incorrectly input.

FIG. 21 is a view illustrating the operation of a light source over time after the door is unlocked.

### BEST MODE

Hereinafter, detailed embodiments will be described in detail with reference to the accompanying drawings. However, the present disclosure is limited to the embodiments in which the spirit of the present disclosure is proposed, and other degenerate idea or other embodiments included in the scope of the present disclosure may be easily proposed by addition, changes, deletions, etc. of other elements.

Hereinafter, a refrigerator will be described as an example of a home appliance, but the description of the refrigerator according to the present disclosure may be applied to various home appliances including a cabinet having a space therein and a door configured to open and close the space. The home appliance may include, for example, an air conditioner, a clothes manager, a washing machine, a dryer, a dish washing machine, a cooking appliance, and the like.

Furthermore, it should be noted that the home appliance of the present disclosure is not limited to home appliances in which the interior space of the cabinet is open and closed, and can also be applied to home appliances in which the interior space of the cabinet is not open and closed.

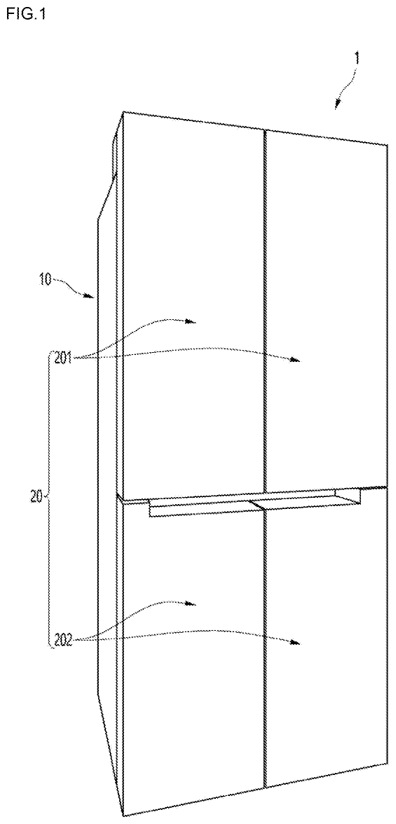

Prior to a description, directions are defined. In an embodiment of the present disclosure, a direction toward a door is defined as a front direction with respect to a cabinet illustrated in FIG. 1, a direction toward the cabinet with respect to the door is defined as a rear direction, a direction toward a bottom on which a refrigerator is installed is defined as a downward direction, and a direction away from the bottom is defined as an upward direction.

FIG. 1 is a perspective view of a refrigerator according to an embodiment.

Referring to FIGS. 1, a refrigerator 1 according to an embodiment of the present disclosure may include a cabinet 10 defining a storage space (or storage section) and a door 20 for opening and closing the storage space of the cabinet 10.

For example, the cabinet 10 may form the storage space partitioned in a vertical direction, a refrigerating compartment may be formed at an upper portion, and a freezing compartment may be formed at a lower portion. The refrigerating compartment may be referred to as an upper storage space, and the freezing compartment may be referred to as a lower storage space.

The door 20 may open and close each of the refrigerating compartment and the freezing compartment. For example, the door 20 may be rotatably mounted on the cabinet 10, and the refrigerating compartment and the freezing compartment may each be opened and closed by rotation. Alternatively, the door 20 may be configured to open and close the refrigerating compartment and/or the freezing compartment by being drawn in and out.

The door 20 may include a refrigerating compartment door 201 for opening and closing the refrigerating compartment and a freezing compartment door 202 for opening and closing the freezing compartment. The refrigerating compartment door 201 may be referred to as an upper door, and the freezing compartment door 202 may be referred to as a lower door.

The refrigerating compartment door 201 may include a pair of a left refrigerating compartment door and a right refrigerating compartment door that are arranged side by side. The left refrigerating compartment door and the right refrigerating compartment door may open and close the refrigerating compartment while being independently rotated. The left refrigerating compartment door and the right refrigerating compartment door may be disposed adjacent to each other and may have the same size.

The freezing compartment door 202 may include a pair of a left freezing compartment door and a right freezing compartment door that are arranged side by side. The left freezing compartment door and the right freezing compartment door may open and close the freezing compartment while being independently rotated. The left freezing compartment door and the right freezing compartment door may be disposed adjacent to each other and may have the same size.

Needless to say, although a refrigerator having a structure in which the refrigerating compartment is defined above the freezing compartment is described as an example in this embodiment, the present disclosure may be applied to all types of refrigerators equipped with a door without being limited to a type of a refrigerator. Additionally, in this embodiment, the refrigerator may include a refrigerating compartment and a freezing compartment as an example, but it is also possible that the refrigerator includes only a refrigerating compartment or only a freezing compartment.

An outer appearance of the front surface of the refrigerator 1 may be formed in the state where the door 20 is closed and may form the out appearance of the refrigerator 1 viewed from the front in the state where the refrigerator 1 is installed.

The door 20 may have a structure in which a front surface selectively emits light and may be configured to glow with set color or brightness. Thus, a user may change front color or brightness of the door 20 without separating or disassembling the door 20 and may change the overall outer appearance of the refrigerator 1.

Hereinafter, the structure of the door 20 will be described in detail with reference to drawings.

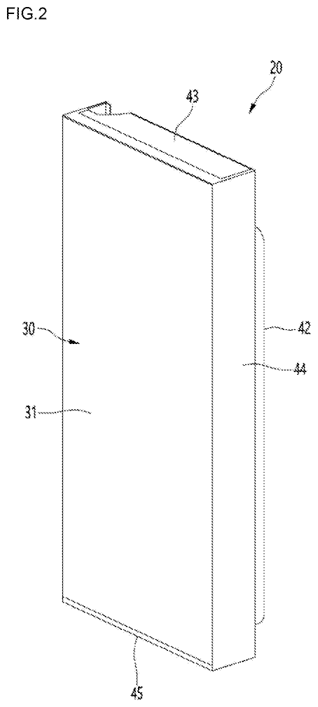

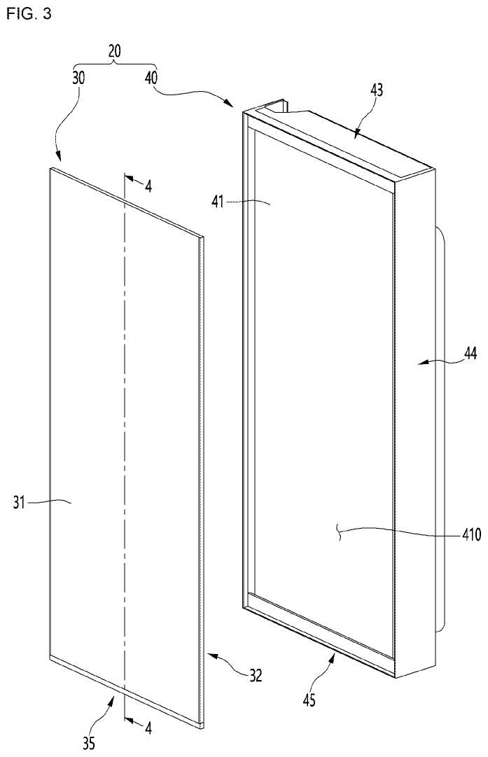

FIG. 2 is a perspective view of a refrigerator door according to an embodiment present disclosure. FIG. 3 is a view illustrating a state where a panel assembly is separated from the refrigerator door.

As illustrated in FIGS. 2 and 3, the door 20 may include a door body 40 forming the overall shape of the door 20, and a panel assembly 30 forming a front appearance of the door 20. That is, the door 20 may be configured in such a way that the panel assembly 30 is mounted on a front surface of the door body 40.

The door body 40 may include a body plate 41 defining a front surface and a door liner 42 defining a rear surface.

The body plate 41 may be formed of a metal material and may be formed in a plate shape having a size corresponding to the panel assembly 30. The door liner 42 may be formed of a plastic material and may form a bottom shape of the door 20.

The door body 40 may further include a side decoration 44 forming right and left side surfaces of the door body 40. The side decoration 44 may connect right and left side ends of the body plate 41 and right and left side ends of the door liner 42.

The door body 40 may include an upper cap decoration 43 and a lower cap decoration 45 that form top and bottom surfaces of the door body 40. The upper cap decoration 43 may be connected to an upper end of the side decoration 44, an upper end of the body plate 41, and an upper end of the door liner 42. The lower cap decoration 45 may be connected to a lower end of the side decoration 44, a lower end of the body plate 41, and a lower end of the door liner 42. However, the structure of the door body 41 is not limited to this.

An outer appearance of the door body 40 may be formed by the body plate 41, the door liner 42, the side decoration 44, the upper cap decoration 43, and the lower cap decoration 45.

An insulator may be filled in an internal space of the door body 40, which is formed by coupling the body plate 41, the door liner 42, the side decoration 44, the upper cap decoration 43, and the lower cap decoration 45, and may provide an insulation structure to prevent heat from being transferred through the door 20. The insulator may be formed, for example, as a time elapses after a foaming liquid is filled. The door body 40 may be provided with an injection hole for filling the foaming liquid.

An opened forward panel receiving space 410 may be formed on a front surface of the door body 40. That is, front ends of the side decoration 44, the upper cap decoration 43, and the lower cap decoration 45 may protrude more forward than the front surface of the body plate 41.

A panel receiving space 410 that is opened forward may be defined at a front side of the door body 41. The panel receiving space 410 may be formed with a size corresponding to the size of the panel assembly 30 and the panel assembly 30 may be inserted into the panel receiving space 410. A circumference of the panel assembly 30 may be supported by a circumferential surface of the panel receiving space 410, that is, protruding portions of the side decoration 44, the upper cap decoration 43, and the lower cap decoration 45.

The panel assembly 30 may be formed in a plate shape as a whole and may be formed with a size corresponding to a front surface of the door body 40. Thus, when the panel assembly 30 is mounted on the front surface of the door body 40, the panel assembly 30 may shield the front surface of the door body 40 and may form an outer appearance of the front surface of the door 20. Since the panel assembly 30 may form the outer appearance of the front surface of the door 20, the panel assembly 30 may be referred to as a door panel, and since the panel assembly 30 may form the outer appearance of the front surface of the refrigerator 1, the panel assembly 30 may also be referred to as an exterior panel.

In the state where the panel assembly 30 is mounted on the door body 40, a rear surface of the panel assembly 30 may be fixed in contact with the body plate 41. To fixedly mount the panel assembly 30, a lower end of the panel assembly 30 may be caught and restrained with a lower end of the lower cap decoration 45, and an upper end of the panel assembly 30 may be coupled to an upper end of a front surface of the upper cap decoration 43 to firmly couple the panel assembly 30 to the door body 40. The panel assembly 30 may be detachably mounted from the door body 40 for services and maintenance.

A front surface of the panel assembly 30 may be exposed forward in the state where the panel assembly 30 is mounted on the door body 40, and the panel assembly 30 may substantially form the outer appearance of the front surface of the door 20. The panel assembly 30 may be configured to emit light from an entire front thereof and may be configured to glow with various colors.

To this end, a lighting device 36 may be provided inside the panel assembly 30. A wire may be connected to the lighting device 36 in order to supply and control power. The wire may be exposed outside the rear surface of the panel assembly 30, and a connector may be provided on an end of the wire.

A structure connected to the connector of the wire to supply power to the lighting device 36 may be provided on a front surface of the door body 40.

Hereinafter, the structure of the panel assembly 30 will be described in more detail with reference to drawings.

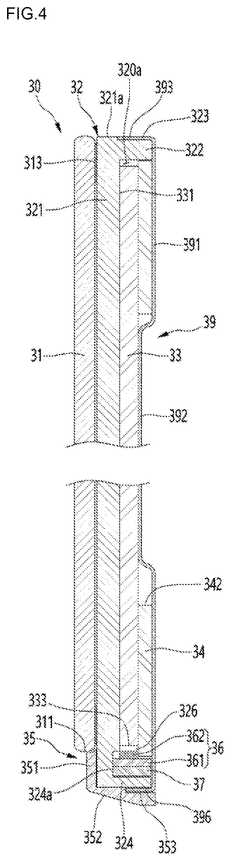

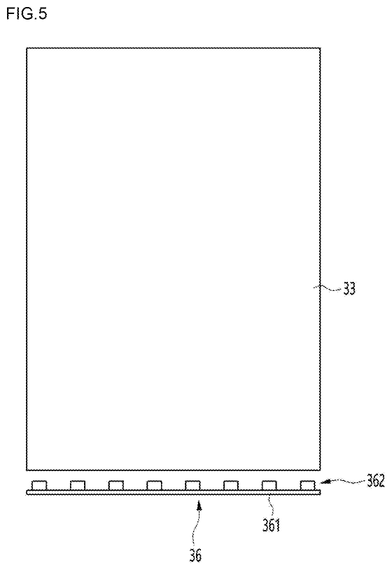

FIG. 4 is a cross-sectional view taken along line 4-4 of FIG. 3, and FIG. 5 is a view illustrating the disposition of a light guide plate and a light source.

Referring to FIGS. 4 and 5, the panel assembly 30 may include a front plate 31 forming an outer appearance of the front surface, the lighting device 36 for emitting light to cause the front plate 31 to glow, a light guide plate 33 for guiding the light emitted from the lighting device 36, and a diffusion member 32 allowing the light guide plate 33 to be spaced apart from the front plate 31 and diffusing the light. The diffusion member 32 may also be referred to as a support member in terms of supporting the light guide plate 33.

The lighting device 36 and the light guide plate 33 may be mounted or supported on the diffusion member 32.

The panel assembly 30 may further include a back cover 39 defining a rear surface of the panel assembly 30.

The front plate 31 may be formed in a rectangular plate shape and may be formed of a material that transmits light therethrough. For example, the front plate 31 may be formed of a glass material such as blue glass, white glass, and vapor deposition glass or may be formed of other materials for transmitting light therethrough, such as ABS, PMMA, or PC. The front plate 31 may be referred to as a transparent plate or an out plate.

The front plate 31 may be formed to be transparent to allow light reflected by the light guide plate 33 to be transmitted. In this case, transparency may be defined to a degree to which light reflected from the light guide plate is transmitted and irradiated to the outside.

The front plate 31 may be formed to have color and may be formed to represent different colors according to an operation or on and off states of the lighting device 36. For example, a specific design or pattern may be printed on the front plate 31 to have specific color. A film with a specific design or pattern printed thereon may be added to the front plate 31, surface treatment such as imprinting, etching, and glass printing may be performed on the panel 21, or a coating or deposition layer having specific color and texture may be formed to form an outer appearance of the front plate 31.

The front plate 31 may be configured to transmit light emitted from the lighting device 36 but components behind the front plate 31 may not be seen therethrough. That is, in the state where the lighting device 36 is turned off, components inside the panel assembly 30 may be prevented from being seen to the outside through the front plate 31 due to the color of the front plate 31.

In this case, a color layer 311 having color may be formed on the front plate 31. In an off state, the color layer 311 may be formed to have at least color having brightness equal to or greater than zero other than black. That is, in a state where the refrigerator 1 is installed, the front surface of the refrigerator 1 may be displayed in a color other than black, and the front color of the refrigerator may be changed according to an operation of the lighting device 36.

In the panel assembly 30, the entire front surface of the front plate 31 may be exposed to the outside. Thus, the light diffused by the diffusion member 32 may be transmitted through the front plate 31 as a whole, and thus, the entire front surface of the front plate 31 may glow.

A rear surface of the front plate 31 may be coupled to a front surface of the diffusion member 32.

The light guide plate 33 may be positioned at a rear spaced apart from the front plate 31 by the diffusion member 32 and may be configured to guide light emitted from the lighting device 36 disposed at the upper end of the light guide plate 33 forward.

For example, the light guide plate 33 may be formed of transparent acrylic, plastic, or a transparent polymer material. The light guide plate 33 may have a diffusing agent added thereto for diffusing light entrance on the light guide plate 33 or a pattern for diffusing light may be further formed on the light guide plate 33. Thus, light may be transferred to the front plate 31 by the light guide plate 33, and in this case, a pattern of the light guide plate 33 may be set to cause the entire front surface of the front plate 31 to glow with uniform brightness.

A load of the light guide plate 33 may be supported by the diffusion member 32 and a front surface of the light guide plate 33 may be pressed toward the diffusion member 32 by the back cover 39.

The diffusion member 32 may be disposed between the front plate 31 and the light guide plate 33. The diffusion member 32 may allow the light guide plate 33 to be maintained at a predetermined distance from the front plate 31 and may diffuse light emitted from the light emission surface of the light guide plate 33.

The front surface of the diffusion member 32 may support the front plate 31 and opposite side surfaces of the diffusion member 32 may restrain both ends of the light guide plate 33. The front surface of the diffusion member 32 may have a size greater than or equal to that of the light guide plate 33, and in the state where the light guide plate 33 is mounted, the rear surface of the diffusion member 32 and the light guide plate 33 may be maintained in the state of being in surface contact with each other.

The diffusion member 32 may include a plate-shaped front surface portion 321, on which the front plate 31 is mounted, and an extension portion extending from a circumference of the front surface portion 321. The front surface portion 321 and the extension portion may define an accommodation space 320a in which the light guide plate 33 is disposed.

The extension portion is disposed to cover the circumference of the light guide plate 33. The circumference of the light guide plate 33 may include, for example, a top surface, a bottom surface, and both side surfaces.

For example, the extension portion may include an upper extension portion 322 extending from an upper end of a rear surface of the front surface portion 321, a lower extension portion 324 extending from a lower end of the rear surface of the front surface portion 321, and a pair of side surface portions extending from both left and right ends of the front surface portion 321.

The upper extension portion 322, the lower extension portion 324, and the pair of side surface portions may define the accommodation space 320a in which the light guide plate 33 is disposed. Thus, the diffusion member 32 not only serves to diffuse light, but also serves to accommodate and support the light guide plate 33.

The front surface portion 321 may be formed like a plate corresponding to the front plate 31, and a front surface of the light guide plate 33 may be in close contact with a rear surface of the front surface portion 321.

According to this embodiment, since the front surface portion 321 of the diffusion member 32 is entirely disposed between the front plate 31 and the light guide plate 33, even if the light guide plate 33 is deformed by the heat, the light guide plate 33 may be prevented from being in direct contact with the front plate 31. Thus, it is possible to prevent a dark area such as stains from occurring on the front plate 31.

The front surface portion 321 and the rear surface of the front plate 31 may be coupled to each other by an adhesion portion 313. The adhesion portion 313 may include, for example, a sealant or a double-sided tape.

The side surface portions may extend backward from right and left side ends of the front surface portion 321 and may be formed to restrain right and left side ends of the light guide plate 33. The side surface portions may be spaced apart from at least one of both left and right side surfaces of the light guide plate 33. When the light guide plate 33 moves to left and right sides, the side surface portions may be in contact with at least one surface of both the left and right side surfaces to restrict the at least one surface. When it is considered that the light guide plate 33 is expanded by heat, the side surface portions may be spaced apart from at least one of the left and right side surfaces of the light guide plate 33.

Each of the upper extension portion 322 and the lower extension portion 324 extends backward from the front surface portion 321, and a length of each of the upper extension portion 322 and the lower extension portion 324 is greater than a thickness of the light guide plate 33.

The diffusion member 32 may be made of a material for transmitting light therethrough and may be entirely formed by injection or extrusion as a single component.

The diffusion member 32 may be made of a transparent or translucent material as a whole. The diffusion member 32 itself may be provided to have a color. Thus, when viewed from the front of the panel assembly 30, a color, texture, or shape of the front surface of the panel assembly 30 may be determined by the diffusion member 32.

The diffusion member 32 may further include a light guide plate support 326 supporting a bottom surface 333 of the light guide plate 33. The light guide plate support 326 may extend backward from the rear surface of the front surface portion 321 and may be disposed above the lower extension portion 324 to be spaced apart from the lower extension portion 324.

To stably support the load of the light guide plate 33, the diffusion member 32 may include a plurality of light guide plate supports 326. The plurality of light guide plate supports 326 may be disposed to be spaced apart from each other in the horizontal direction.

The lighting device 36 may be accommodated in the diffusion member 32. The diffusion member 32 may include a receiving groove 324a (or receiving portion) that receives a portion of the lighting device 36.

The receiving groove 324a may be defined as a rear portion of the front surface portion 321 is recessed forward. Thus, the portion in which the receiving groove 324a is defined in the front surface portion 321 may be thinner than other portions.

The receiving groove 324a may be defined between the light guide plate support 326 and the lower extension portion 324. Thus, when the lighting device 36 is received in the receiving groove 324a, the lighting device 36 may be disposed below the light guide plate support 326.

The lighting device 36 may include a substrate 361 and the light source 362. The substrate 361 may be provided in a plate shape to be elongated in the left and right direction.

The plurality of light sources 362 may be arranged at a constant interval on the substrate 361. The light source 362 may be disposed to radiate light toward the bottom surface 333 of the light guide plate 33. That is, the bottom surface 333 of the light guide plate 33 is a light entrance surface, and the front surface 331 of the light guide plate 33 is the light emission surface.

The substrate 361 may provide a space in which the light source 362 may be continuously disposed from the left end to the other side end of the light guide plate 33.

The light source 362 may be disposed vertically below the bottom surface 333 of the light guide plate 33, i.e., may be disposed to face the bottom surface 333 of the light guide plate 33.

The light source 362 may be provided as, for example, an LED. The light source 362 may be configured as an RGB LED capable of irradiating light with various colors according to a control of the controller 13, which will be described later. That is, the light source 362 may emit light with various colors under control of the controller 13 that will be described later, and thus the front plate 31 may glow with color set by the controller 13. A color of the front appearance of the refrigerator 1 may be determined according to color of the front plate 31.

The light source 362 may include an LED for emitting light with specific color other than the RGB LED and may include a combination of a plurality of LEDs for emitting light with different colors. For example, the plurality of light sources 362 may include red, green, and blue LEDs and may sequentially and repeatedly arranged. Under control of the controller 13, operations of the light sources 362 may be combined to cause the front plate 31 to glow with desired color.

An interval between the light sources 362 may be smaller than the right and left width of the light guide plate support 326, and thus the light guide plate support 326 may be disposed between the light sources 362. Thus, the light emitted from the light source 362 may pass between two adjacent light guide plate supports 326 and be irradiated to the bottom surface 333 of the light guide plate 33.

The panel assembly 30 may further include a substrate supporter 37 seated on the lower extension portion 324 of the diffusion member 32.

The substrate supporter 37 may support the substrate 361 while being seated on the lower extension portion 324. A substrate supporter 37 may dissipate heat generated by the lighting device 36 by thermal conduction.

The substrate supporter 37 may be made of, for example, a metal material. For example, the substrate supporter 37 may be made of an aluminum material having high thermal conductivity. The substrate supporter 37 may be extruded with a metal material to have the same cross-sectional shape in the longitudinal direction.

A portion of the substrate supporter 37 may be received in the receiving groove 324a. The substrate supporter 37 may be in contact with the back cover 39 while the back cover 39 is assembled. Thus, the heat generated by the lighting device 36 may be transferred toward the back cover 39 through the substrate supporter 37 and may be dissipated through the back cover 39.

The panel assembly 30 may further include a rear supporter 34 supporting the rear surface of the light guide plate 33. The rear supporter 34 may be provided in a plate shape and may be attached to the rear surface of the light guide plate 33 by an adhesive.

The rear supporter 34 may be made of an opaque material through which light transmission is restricted. The rear supporter 34 may be accommodated in the accommodation space 320a defined by the diffusion member 32. The upper extension portion 322 may cover an upper side of the rear supporter 34, and the side portions 327 and 328 may cover both the side surfaces of the rear supporter 34.

A bottom surface of the rear supporter 34 may be disposed above the substrate 361. For example, a bottom surface of the rear supporter 34 may be seated on a top surface of the substrate 361.

In this case, the upward movement of the substrate 361 may be restricted by the rear supporter 34. Since the bottom surface 333 of the light guide plate 33 is seated on the top surface of the light guide plate support 226, a set interval may be maintained between the bottom surface of the light guide plate 33 and the light source 362.

As described above, the lighting device 36 may be maintained in the fixed state, and a distance between the light guide plate 33 and the light source 362 may also be maintained at a set distance, and thus, the light irradiated from the light source 362 may be incident into the light guide plate 33 at a designed angle. Thus, the light irradiated from the light source 362 may be effectively irradiated toward the light guide plate 33, and the light reflected through the light guide plate 33 may allow the front plate 31 to glow with set brightness.

In another aspect, the rear supporter 34 may be seated on the light guide plate support 326.

The rear supporter 34 may include an opening 342 through which a portion of the back cover 39 passes.

The back cover 39 may include a cover body 391 and a bent portion extending from an edge of the cover body 391 in the horizontal direction.

The cover body 391 may be in contact with the rear surface of the rear supporter 34. The cover body 391 may be attached to the rear supporter 34 by the adhesive or may be coupled to the rear supporter 34 by a coupling member such as a screw.

The bent portion may extend forward from the edge of the cover body 391 and may

include an upper bent portion 393, a lower bent portion 396, and a pair of side bent portions. The bent portion may be in contact with the diffusion member 32. For example, the bent portion may adhere to the extension portion of the diffusion member 32 by the adhesive.

For example, the upper bent portion 393 may be seated in an upper seating groove 323 having a recessed shape defined in the upper extension portion 322 of the diffusion member 32.

The lower bent portion 396 may be in contact with a bottom surface of the lower extension portion 324 of the diffusion member 32. The side bent portions may be seated in the recessed side seating grooves defined in the side extension portions.

In this embodiment, since the diffusion member 32 supports the light guide plate 33 and fixes a position of the light guide plate 33, and the back cover 39 is coupled to surround a portion of the diffusion member 32, the number of components of the panel assembly 30 itself may be reduced to reduce a thickness of the panel assembly in the front and rear direction.

The cover body 391 may further include a pressing portion 392 bent toward the light guide plate 33. The pressing portion 392 may pass through the opening 342 of the rear supporter 34 so as to be in contact with the rear surface of the light guide plate 33.

In this embodiment, the cover body 391 may press the rear supporter 34 toward the rear surface side of the light guide plate 33 while being in contact with the rear surface of the rear supporter 34, and the pressing portion 392 may directly press the light guide plate 33.

The receiving groove 324a may be defined at a position equal to or lower than that of the bottom surface 311 of the front plate 31. That is, a portion of the front surface portion 321 may extend further downward than the bottom surface 311 of the front plate 31.

The diffusion member 32 may diffuse the light irradiated from the light emission surface of the light guide plate 33. Since a portion of the diffusion member 32 is disposed lower than the bottom surface 311 of the front plate 31, there is a possibility that the light passing through the diffusion member 32 is directly irradiated to the outside without passing through the front plate 31. To prevent this phenomenon, the panel assembly 30 according to this embodiment may further include a lower trim 35.

The lower trim 35 may be coupled to the diffusion member 32 by a coupling means such as an adhesion portion or a hook.

The lower trim 35 may include a first portion 351 extending in the vertical direction and a second portion 352 extending in the horizontal direction from a lower end of the first portion 351.

At least the first portion 351 may be provided to be transparent or translucent and, as necessary, may be provided with a specific color.

The first portion 351 may cover a portion of the diffusion member 32 extending downward from the bottom surface 311 of the front plate 31. For example, the first portion 351 may be disposed to face the receiving groove 324a in front of the receiving groove 324a in the diffusion member 32.

The second portion 352 may support the lower extension portion 324. The second part 352 may include a seating groove 393 for seating the lower bent portion 396 of the back cover 39.

In the above embodiment, the structure of the panel assembly 30 may be changed in various ways, and is not limited to the structure of the panel assembly 30 mentioned above, and some components may be deleted, changed, or added.

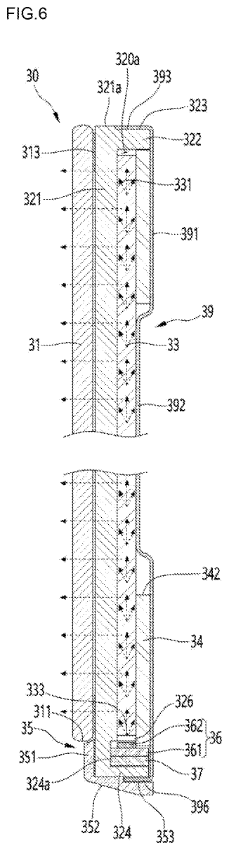

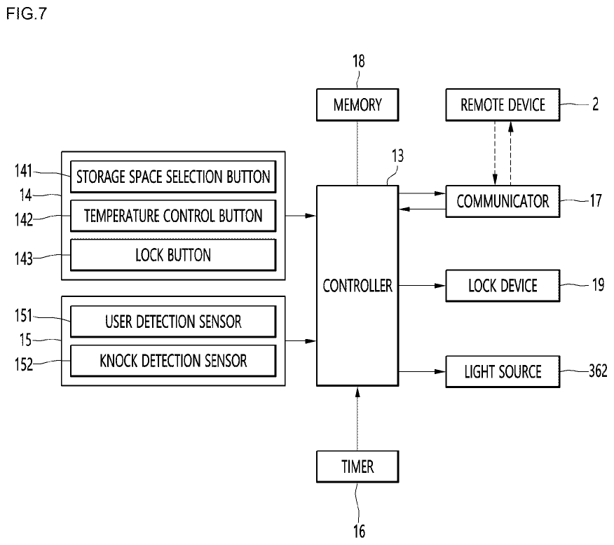

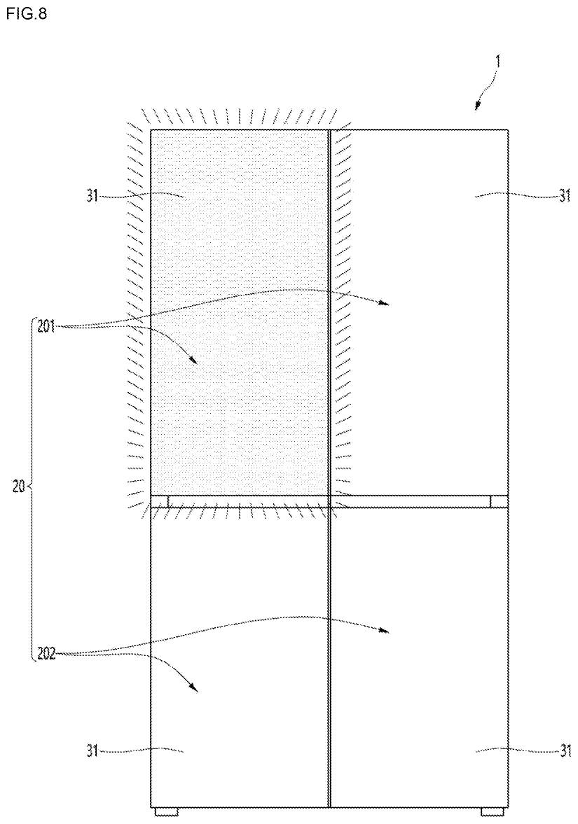

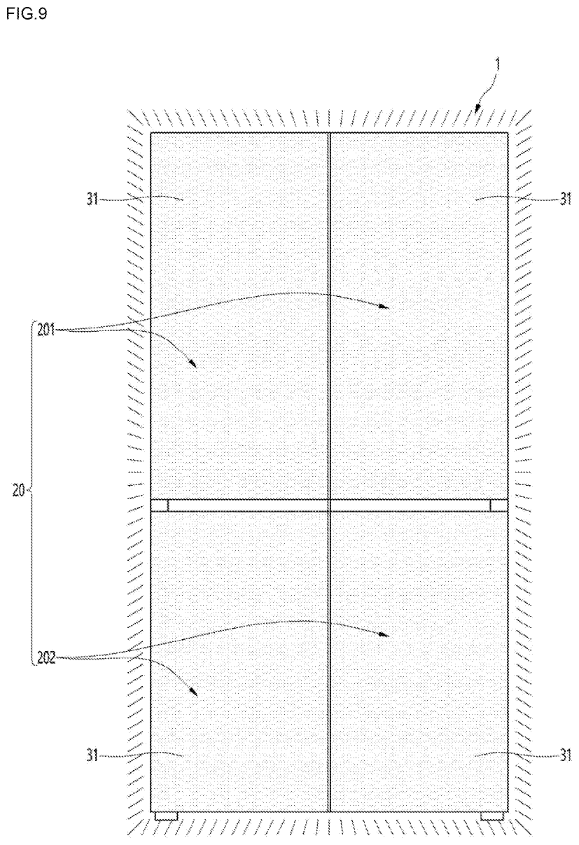

FIG. 6 is a vertical cross-sectional view illustrating a light emitting state of the panel assembly. FIG. 7 is a block diagram illustrating a flow of a control signal of the refrigerator, FIG. 8 is a view illustrating a state where some of a plurality of doors emit light, and FIG. 9 is a view illustrating a state where all doors in a refrigerator emit light.

Referring to FIGS. 6 to 9, as illustrated in the drawings, in the refrigerator 1 according to an embodiment of the present disclosure, a front surface of the door 20 may glow via an operation of the lighting device 36.

The front surface of the door 20 may be turned on or off and may glow with any one of a plurality of colors under control of the controller 13.

The operation of the lighting device 36 may be performed by manipulation of a manipulator 14 of a user. The manipulator 14 may be disposed at one side of the refrigerator 1, and for example, may be disposed at one side of the cabinet 10. Needless to say, as necessary, the manipulator 14 may be included in the door 20 or manipulation may be input by touching and manipulating the front plate 31. That is, the user may directly manipulate the manipulator 14 to set an operation of the lighting device 36 and may turn on or off the lighting device 36.

The user may set an operation state of the lighting device 36, such as an operation time and an operation condition of the lighting device 36 and emission color of the light source 362 through manipulation of the manipulator 14. Various commands related to the operation of the refrigerator may be input by manipulating the manipulator 14. As necessary, the manipulator 14 may be configured as a display for information display and manipulation.

By way of example, the manipulator 14 may include at least one of buttons 141, 142, and 143.

When the manipulator 14 includes a plurality of buttons, the manipulator 14 may include a button 141 for selecting a storage space (for example, a refrigerating compartment button and a freezing compartment button) and a temperature control button 142 for controlling the temperature of the storage space (for example, an up button and a down button), and a lock button 143 for locking or unlocking the button.

If the lock button 143 is referred to as a first button, the remaining buttons may be referred to as a second button and a third button. There is no limit to the order of buttons.

When the user presses the lock button 143 for a reference time, all buttons may be locked. In this state, even if the buttons are pressed, the button press signal is not transmitted to the controller 13. On the other hand, if the lock button 143 is pressed for the reference time, all buttons can be unlocked. In this state, a signal corresponding to the button pressed by the user may be transmitted to the controller 13.

The lighting device 36 may also be manipulated in operation and set in operation condition through a remote device 2 spaced apart from the refrigerator 1. The refrigerator 1 may communicate with the remote device 2 through a communicator 17 connected to a controller 13, and the user may control an operation of the lighting device 36 through the remote device 2.

The communicator 17 may communicate with the remote device 2 and/or a server that manages the home appliance in various ways. As an example, the communicator 17 may have a structure capable of communicating in at least one of wired, wireless, and short-range communication (Bluetooth, Wi-Fi, Zigbee, NFC, or the like). The remote device 2 may be a variety of devices capable of communication, such as a dedicated terminal, mobile phone, tablet, portable PC, desktop PC, remote control, or Bluetooth speaker.

The user may manipulate and set the operation state of the lighting device 36, such as an operation time and an operation condition of the lighting device 36 and emission color through manipulation of the remote device 2. For example, the lighting device 36 may be simply manipulated and set through an application or a dedicated program installed in a portable phone of the user.

The refrigerator 1 may further include a timer 16. The timer 16 can count the elapsed time since a specific event occurs.

Meanwhile, the lighting device 36 may be operated based on a detection result by the sensing part 15.

For example, the sensing part 15 may include a user detection sensor 151 that detects the user's proximity. The user detection sensor may be a variety of devices that can detect the user's proximity to the refrigerator, such as an infrared sensor, an ultrasonic sensor, or a laser sensor.

The user detection sensor 151 may be provided on one side of the cabinet 10 or the door 20, and may be disposed in various locations to detect the proximity of a user. A plurality of the sensors may be provided at different locations.

Thus, when the user approaches the refrigerator 1 by a set distance for use of the refrigerator 1, the user detection sensor 151 may detect this and may transfer a signal to the controller 13 to turn on the lighting device 36. When the user moves away from the refrigerator 1, the user detection sensor 151 may detect this and may transfer a signal to the controller 13 to turn off the lighting device 35.

If the user detection sensor 151 is provided in the cabinet 10, the user detection sensor 151 may be located on the front surface of the cabinet 10 corresponding to the space between the upper door and the lower door. Since the upper door and the lower door are spaced apart from each other, a gap exists between the upper door and the lower door.

Therefore, when the user detection sensor 151 is disposed at a position corresponding to the gap, the user detection sensor 151 can detect the user's proximity.

The sensing part 15 may further include a knock detection sensor 152. The knock detection sensor 152 may be installed on the door 20, for example. When a knock input is detected by the knock detection sensor 152 and the detected knock input corresponds to a normal knock input, the controller 13 can change the state of the refrigerator 1 in response to the knock input.

For example, some of the doors 20 may include a panel capable of transmitting light and may include a knock detection sensor 152, and a lighting device may be provided on some of the doors 20 and/or the cabinet 10. When a normal knock input is detected, the lighting device is turned on and the space inside the cabinet 10 and/or the door storage space provided in some of the doors 20 can be checked through the panel without opening some of the doors 20.

Of course. at least one of the remaining doors among the doors 20 may include a knock detection sensor 152. When some of the plurality of doors 20 are used as doors (visualization doors) to check the internal space of the storage space, some of the doors 20 may not be used in the pattern input process for unlocking, which will be described later.

Alternatively, in the pattern input process, a knock detection sensor of the visualization door may also be used, but the knock input order of the visualization door may be set to the second or later order.

The refrigerator 1 may further include a locking device 19 for locking the door.

One storage space can be opened and closed by one or two or more doors 20. At this time, when the refrigerator 1 is used in a guest house where several people can stay together or in a space that can be used jointly, it is necessary to block users without access authority from accessing the storage space by opening the door. Alternatively, even within a home, there is a need to block doors from being opened by children or the like, for specific storage spaces.

Based on this necessity, the refrigerator of this embodiment may further include a locking device 19 for locking the door 20. The locking device 19 may fix the door 20 and the cabinet 10 to prevent rotation (or opening) of the door 20 in a state where the door 20 is closed.

For example, the locking device 19 may include a moving member driven by a driver and a fixing member to which the moving member is selectively coupled. In a state where the moving member is coupled to the fixed member, the door 20 is in a locked state. On the other hand, when the moving member is disconnected from the fixing member, the door 20 is in an unlocked state. When the door 20 is in an unlocked state, the door 20 can be rotated (or opened).

The moving member may be provided in one of the door 20 and the cabinet 10, and the fixing member may be provided in the other one of the door 20 and the cabinet 10.

In this specification, “locking function” may mean a function of using the locking device 19.

“The lock function is activated” means that the locking device 19 is activated and the door 20 is maintained in a locked state, and only users with access authority can unlock the door.

“Lock function is deactivated” means a state where the locking device 19 is not operated and the door 20 is basically maintained in an unlocked state, allowing the user to freely open and close the door 20.

The locked state of the door 20 refers to a state where the rotation (or opening) of the door 20 is restricted by the locking device 19, and the unlocked state of the door 20 refers to a state where the rotation (or opening) of the door 20 is allowed by the locking device 19. Accordingly, when the lock function is deactivated, the door remains unlocked.

When the lock function is activated, the door can be changed from a locked state to an unlocked state, or from an unlocked state to a locked state.

The user can activate or deactivate the locking function. In a state where the lock function is activated, the door can be unlocked through a user's input of a pattern for unlocking. After the door is in the unlocked state, when a set time has elapsed, the door may automatically change back to the locked state.

In some cases, the lock function may be set to be activated only when the refrigerator 1 can communicate with the server. That is, if the refrigerator 1 is unable to communicate with the server, it is possible to set the lock function through the manipulator 14 of the refrigerator 1 to be impossible to activate.

Alternatively, even when the refrigerator 1 cannot communicate with the server, the lock function can be set to be activated through the manipulator 14 of the refrigerator 1, and when communication with the server becomes possible later, the pattern information input in the process of activating the function may be transmitted to the server.

By using the locking device 19, the lock function of the door 20 can be independently activated or deactivated for each storage space. For example, the lock function of the refrigerating compartment door 201, which opens and closes the refrigerating compartment, may be activated, and the lock function of the freezing compartment door 202, which opens and closes the freezing compartment, may be deactivated, and vice versa. Alternatively, the lock function of the entire door 20 may be activated.

Additionally, in a state where the lock function of all doors 20 is activated, all doors 20 may be unlocked, or only a selected door 20 among all doors 20 may be unlocked.

The operation state of the lighting device operated by the controller 13 is now described. As illustrated in FIG. 6, when the lighting device 36 is turned on according to an instruction of the controller 13, light emitted from the light source 362 may be directed toward the bottom surface 333 of the light guide plate 33 and then guided along the light guide plate 33.

In this case, the light guided by the light guide plate 33 may pass through the light emission surface and be diffused while passing through the front surface portion 321, and then, may pass through the front plate 31 and be transmitted to the outside. Thus, the entire front plate 31 may brightly glow, and the front surface of the door 20 may glow with a set brightness or color.

The lighting device 36 may be turned on to cause the front surface of the door 20 to glow brightly, and the front surface of the door 20 may glow with set color by light emitted from the light source 362. In this case, the front color of the door 20 may be different color or brightness from in the state where the lighting device 36 is turned off.

That is, a color of the front surface of the door 20 may be seen as a color of the front plate 31, and the texture and pattern disposed on the front plate 31 may be seen. In this case, the color of the front plate 31 may be color with a brightness greater than 0 and may be formed in a color other than black. The color of the front surface of the door 20 in the state where the lighting device 36 is turned may also be referred to as a first color (or a background color).

Thus, the front surface of the door 20 may be seen with color of the front plate 31, and in this case, components inside the panel assembly 30 may be seen through the front plate 31 and may not be seen to the outside by the color of the front plate 31.

In this state, the lighting device 36 may be turned on, and when the lighting device 36 is turned on, the front surface of the door 20 may glow with color set by the controller 13.

The front surface of the door 20 can be controlled to glow in a second color different from the first color, and the lighting device 36 can control the light source 362 so that the door 20 glows in the second color according to the control of the controller 13.

At this time, the color emitted from the light source 362 may be different from the second color. That is, since the front plate 31 contains the first color, if light of the second color is irradiated from the light source 362, the light interacts with the first color in the process of passing through the front plate 31 so that the door 20 can actually glow with a third color.

Therefore, in this embodiment, it can mean that controlling the light source 362 to emit a specific color from the door 20 actually controls the color emitted from the light source 362 by considering the color of the front plate 31 itself.

That is, in a state where the light source 362 is turned on, the color glowing from the door 20 may be a mixture of the color of the front plate 31 and the color of the light emitted from the light source 362.

Some of the plurality of doors 20 forming the front appearance of the refrigerator 1 may emit light or the plurality of doors 20 may independently emit light to form the front appearance of the refrigerator 1 with set color.

The refrigerator 1 may be operated to cause some doors 20 of a plurality of doors to glow or glow with specific color. That is, all the lighting devices 36 included in the doors 20 may not be operated, but instead, only some of all the doors 20 may glow. For example, any one door 201 of the refrigerating compartment door 201 may glow.

As necessary, the left refrigerating compartment door 201a and the right refrigerating compartment door 201b may glow with different colors. At least two of the doors 20 may be sequentially changed in color and at least two of the doors 20 may be sequentially turned on or off.

In this case, the lighting device 36 included in the panel assembly 30 may be controlled by the controller 13 according to the aforementioned various conditions.

The refrigerating compartment door or the freezing compartment door among the doors may be controlled to glow with different colors.

The controller 13 may control the lighting device 36 to cause one pair of the refrigerating compartment doors 201 to be seen with the first color. The controller 13 may control the lighting device 36 to cause one pair of the refrigerating compartment doors 201 to be seen with the second color.

Hereinafter, specific operational control of the lighting device 36 will be described.

For convenience of explanation, the two doors of the upper door of a refrigerator are referred to as the first door and the second door, and the two doors of the lower door are referred to as the third door and the fourth door.

In the case of the upper first and second doors, the light source 362 may be located below each of the first and second doors. In the case of the lower third and fourth doors, the light source 362 may be located above each of the third and fourth doors. Of course, it is also possible for the light source 362 to be located below each of the third and fourth doors.

Of course, as an optional terminology, it is also possible to refer to the two doors on the lower side as the first door and the second door, and the two doors on the upper side of the first door and the second door as the third door and the fourth door.

Additionally, operation control of the lighting device 36 described below is not limited to the structure of the panel assembly described above. That is, at least one of the plurality of components constituting the panel assembly may be omitted, at least one of the plurality of components may be replaced with another component, or the position or shape of at least one of the plurality of components may be changed.

In this specification, changing the state of the light source 362 may include at least one of changing the light source 362 from an off state to an on state, changing the light source 362 from an on state to an off state, turning at least one LED on while the light source 362 is turned off, turning the light source 362 off while at least one LED is turned on, changing the brightness of the light emitted from the light source 362 while the light source 362 is turned on, changing the brightness or color of the light emitted from some of the plurality of LEDs while the light source 362 is turned on, changing the number of LEDs that are turned on (increasing the number of LEDs that are turned on or decreasing the number of LEDs that are turned on), and changing the color of light emitted from the light source 362 while the light source 362 is turned on.

A state where the light source 362 is turned on may mean that all of the plurality of LEDs are turned on, and a state where the light source 362 is turned off may mean that all of the plurality of LEDs are turned off.

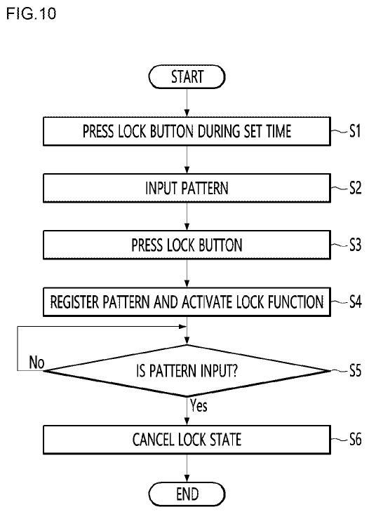

FIG. 10 is a block diagram illustrating a method for activating a lock function and registering a pattern for unlocking according to the first embodiment of the present disclosure.

In the case of the first embodiment of the present disclosure, the lock function may be activated using the manipulator 14 of the refrigerator and a pattern for unlocking may be registered.

Referring to FIGS. 7 and 10, the lock button 143 may be pressed by the user for a set time S1. In this embodiment, the set time may be set differently from the reference time for pressing the lock button 143 to unlock the buttons.

At this time, the set time may be longer than the reference time. Accordingly, when the pressing time of the lock button 143 by the user reaches the reference time, the buttons may be unlocked. When the continuous pressing time of the lock button 143 elapses the set time, the refrigerator 1 may enter a state waiting for a pattern input for unlocking.

In the pattern input waiting state, a pattern for unlocking may be input S2.

Pattern input can be performed by pressing two or more buttons among a plurality of buttons excluding the lock button 143.

For example, in the pattern input waiting state, the user can input a pattern by sequentially pressing the temperature control button (up button or down button), the refrigerating compartment button, and the freezing compartment button.

At this time, pattern input may be performed by pressing a plurality of buttons alternately, or by individually pressing a plurality of buttons one or more times, but pressing at least one button multiple times, or the like.

After the user inputs a pattern for pattern registration, the user may press the lock button 143 to register the input pattern (S3).

When the lock button 143 is pressed after inputting a pattern, the input pattern information may be stored and registered in the memory 18 (S4). When the pattern is registered, the lock function may be activated (S4). The pattern information stored in the memory 18 may be transmitted to the server and stored on the server.

When the lock function is activated, the locking device 19 operates and the door 20 is locked. In this specification, the process of inputting a pattern to activate the lock function can be described as the process of inputting a command to activate the locking function.

According to the type of refrigerator, all of the plurality of doors may be lockable, or some of the plurality of doors may be lockable.

In this embodiment, when the lock function is activated through the refrigerator 1, all lockable doors of a plurality of doors may be set to be in a locked state.

That is, when the lock function is activated through the manipulator 14 of the refrigerator 1, the lock function may be activated or the lock function may be deactivated for all lockable doors.

Of course, when the manipulator 14 is programmed to enable door selection for locking or additionally includes a door selection button, the lock function for each door can be activated/deactivated in the refrigerator 1 as well.

When the lock function is activated and an input of a registered pattern is detected (S5), the door 20 may be unlocked (S6). That is, the door 20 may be changed from the locked state to the unlocked state.

At this time, when the lock function is activated, the user can press the buttons sequentially without pressing the lock button 143 to input a pattern.

If the input pattern is the same as the registered pattern, the door 20 may be unlocked by the locking device 19.

According to this embodiment, it is possible to register a pattern for unlocking using a button on an existing manipulator, so there is an advantage that an additional button or an additional structure for pattern registration is unnecessary, and there is an advantage of preventing anyone without access authority from easily unlocking the lock.

Meanwhile, in this embodiment, pattern registration may be possible for each user. For example, after registering a pattern for a first user, it is also possible to register a pattern for a second user. At this time, the pattern for the first user may be different from the pattern for the second user.

During the pattern registration process, it is also possible to distinguish users by the up and down buttons of the temperature control button. For example, after pressing the up button once, a pattern for the first user may be registered by sequentially pressing a plurality of buttons. Additionally, after pressing the down button once, a pattern for the second user may be registered by sequentially pressing a plurality of buttons.

If the patterns registered for each user are different, the current user can be checked when the door is unlocked, and the controller 13 can obtain refrigerator usage pattern information for each user.

Although not illustrated, the cabinet 10 or the door 20 may be equipped with a camera for photographing the storage space. In the process of closing the door 20 after opening it, the camera may intermittently photograph the storage space. Through comparison of photographed images, it may be possible to check changes in items or food in the storage space before and after opening and closing the door.

Accordingly, the controller 13 can obtain the door being opened, the number of times the door is opened and closed, the storage or use pattern of goods or food, or the like. The obtained information can be transmitted to the server and managed.

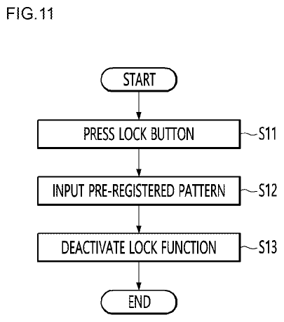

FIG. 11 is a block diagram illustrating a method for inactivating the lock function according to the first embodiment of the present disclosure.

Referring to FIGS. 10 and 11, in a state where the lock function is activated, in order to unlock the door 20, the user may input a pre-registered pattern. When the user inputs a pre-registered pattern, the door 20 may be unlocked.

On the other hand, in a state where the lock function is activated, the user may press the lock button 143 to deactivate the lock function (S11).

While the lock button 143 is pressed, the user can input a pre-registered pattern (S12). Then, the lock function may be deactivated (S13). When the lock function is deactivated, the locked state of the door 20 is released by the locking device 19, and the unlocked state may be maintained.

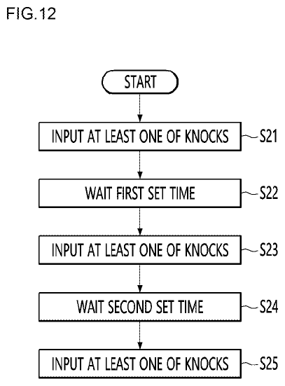

FIG. 12 is a block diagram illustrating a method for activating a lock function and registering a pattern for unlocking according to a second embodiment of the present disclosure.

This embodiment differs from the steps described in FIG. 10 in the pattern input step (S2). Therefore, the pattern input step will be described in detail below.

At least one of the plurality of doors may include a knock detection sensor 152. FIG. 12 illustrates, as an example, a method for inputting a pattern from one door using a knock detection sensor of one of a plurality of doors.

Referring to FIGS. 10 and 12, to input a pattern, after the lock button 143 (or other buttons may also be pressed) is pressed for a set time, the user may input at least one of knocks on the door 20 (S21) (first knock input).

In this embodiment, when the lock button 143 is pressed for a set time, the refrigerator is in a waiting state for pattern input.

Then, the refrigerator waits for the first set time (S22). After the first set time has elapsed, the user can input a knock on the door 20 one or more times (S23) (second knock input).

Then, the refrigerator waits for the second set time (S24). After the second set time has elapsed, the user can input a knock on the door 20 one or more times (S25) (third knock input).

For example, a pattern may be registered by inputting two knocks in the first knock input, one knock in the second knock input, and three knocks in the third knock input.

Pattern information may be stored and registered in the memory 18 and transmitted to the server.

In this way, when a pattern is registered through a knock input, the door may be changed to a locked state. That is, the lock function may be activated.

In this specification, the process of inputting a pattern to activate the lock function can be described as the process of inputting a command to activate the locking function.

In the locked state of the door, when, after knocking twice, waiting for the first input waiting time, after knocking once, waiting for the second input waiting time, and knocking three times, the door 20 may be unlocked.

The first input waiting time may be the same as or different from the second input waiting time. The first input waiting time may be the same as or different from the first set time. The second input waiting time may be the same as or different from the second set time.

Unlike the above embodiment, the third knock input step may be omitted. That is, steps S24 and S25 may be omitted. In this case, when the first knock is inputted once (single), it can be set that a plurality of knocks must be input when the second knock is input. Additionally, when a plurality of knocks are input during the first knock input, it can be set to input a single or a plurality of knocks when the second knock is input. That is, the simpler the registered pattern, the easier it is for a person without access authority to unlock the door, so the pattern registration method may be limited in terms of strengthening security.

In this embodiment as well, pattern registration may be possible for each user. For example, after registering a pattern for a first user, it is also possible to register a pattern for a second user. At this time, the pattern for the first user may be different from the pattern for the second user.

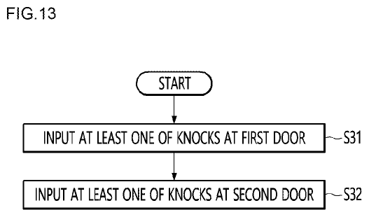

FIG. 13 is a block diagram illustrating a method for activating a lock function and registering a pattern for unlocking according to a third embodiment of the present disclosure.

A plurality of doors may include a knock detection sensor 152. In FIG. 13, as an example, a method for inputting a pattern using a knock detection sensor provided on a plurality of doors will be described. If some of the plurality of doors function as doors that show the cabinet or storage space of the door to the outside, the corresponding doors may be unused when inputting a pattern.

Referring to FIGS. 10 and 13, in order to input a pattern, after the lock button 143 is pressed for a set time, the user may input a knock on the first door one or more times (S31) (first knock input).

Next, the user may input a knock on the second door one or more times (S32) (second knock input).

For example, a pattern may be registered by knocking twice on the first door in the first knock input and knocking three times on the second door in the second knock input.

In this way, when a pattern is registered through a knock input, the door may be changed to a locked state. That is, the lock function may be activated.

In this specification, the process of inputting a pattern to activate the lock function may be described as the process of inputting a command to activate the locking function.

In a locked state of the door, the door 20 may be unlocked by knocking twice on the first door and then knocking three times on the second door.

Of course, in order to strengthen security, it is also possible to register the pattern through, for example, the first knock input through the first door, the second knock input through the second door, and the third knock input through the first door.

This embodiment has been described as an example of inputting a pattern for unlocking using two doors, but unlike this, it is also possible to input a pattern for unlocking using three or more doors.

At this time, the pattern may be registered by sequentially knocking one or more on three or more doors. Even if it is possible to input the unlock pattern using three or more doors, it is also possible to input the pattern using only two of the three doors.

In this embodiment as well, pattern registration may be possible for each user. For example, after registering a pattern for a first user, it is also possible to register a pattern for a second user. At this time, the pattern for the first user may be different from the pattern for the second user.

Meanwhile, as described above, some of the plurality of doors 20 may be used as doors (visualization doors) to show the storage space of the cabinet or door to the outside.

At this time, when the knock input from the visualization door is detected for the first time during the pattern input process using a knock, the pattern input is determined to be abnormal, and a lighting device may be worked to show the storage space of the cabinet or door to the outside through the visualization door.

On the other hand, when a knock input is performed on the visualization door after a knock input from another door, it may be determined that the knock was input during a normal pattern input process.

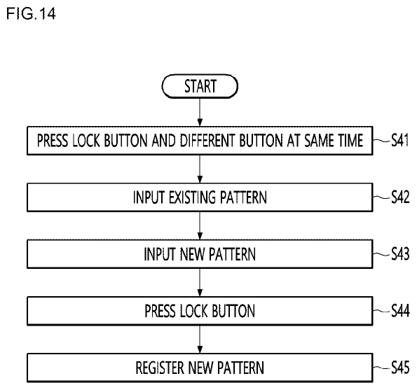

FIG. 14 is a block diagram illustrating a method for changing pattern registration according to the first embodiment of the present disclosure.

Referring to FIG. 14, when the lock function is activated, the user may press the lock button 143 and at least one of different buttons at the same time (S41). When the controller 13 determines that simultaneous pressing of the lock button 143 and at least one of different buttons is detected, the controller 13 may control the refrigerator 1 to be in a waiting state for pattern change.

For example, if the lock button 143 and the temperature control button are pressed at the same time, a waiting state may be entered for pattern change.

In this state, the user may input an existing pattern (S42). After inputting an existing pattern, a new pattern to be registered may be input (S43).

In this embodiment, the method for inputting an existing pattern and the method for inputting a new pattern may be the same as any one of the method described in FIG. 10, the method described in FIG. 12, and the method described in FIG. 13, so detailed description will be omitted.

After the new pattern is input, the lock button 143 may be pressed to register the new pattern (S44). When the lock button 143 is detected, a new pattern is stored and registered in the memory 18 (S45), and new pattern information may be transmitted to the server. Information stored in the server may be checked through the remote device 2. For example, newly registered pattern information may be checked on the remote device 2.

Even if the existing pattern is changed to a new pattern, there is no change in the number or target of doors for which the lock function has already been activated. That is, the lock function set on the existing door can be maintained as is.

According to this embodiment, the type of button the user must press to register a pattern and the type of button the user must press to change the pattern are different, so pattern registration may be prevented from being easily changed by a user without access authority.

As another example, it is possible to add the step of pressing the lock button 143 after the existing pattern is input in FIG. 14 but before the new button is input.

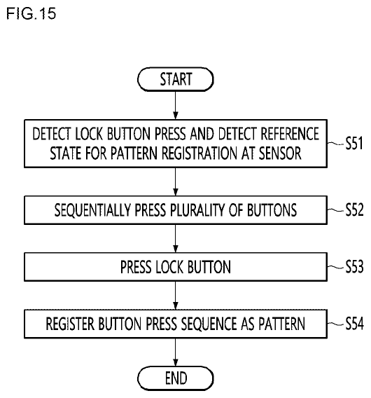

FIG. 15 is a block diagram illustrating a method for activating a lock function and registering a pattern for unlocking according to a third embodiment of the present disclosure.

Referring to FIG. 15, in order to register a pattern for unlocking, the user may press the lock button 143 and bring a portion of the user's body close to the user proximity sensor 152.

The user proximity sensor 152 may detect whether the user is within a limit distance for pattern registration. In the user proximity sensor 152, a state where the user is detected to be within a limit distance for pattern registration may be described as detecting a reference state. The limit distance may be set smaller than the reference distance.

Accordingly, when the pressing of the lock button 143 is detected and the reference state for pattern registration is detected by the sensor (S51), the controller 13 may control the refrigerator to be in a waiting state for pattern registration.

In this state, the user can input a pattern by pressing a plurality of buttons (S52). The method for registering a pattern by pressing a plurality of buttons is the same as that described in FIG. 10, so detailed description will be omitted. Alternatively, it is also possible to register a pattern through a knock input as described in FIGS. 12 and 13.

After pressing the plurality of buttons, the input pattern may be stored and registered in the memory 18 by pressing the lock button 143 (S53). That is, the button press sequence may be registered as a pattern (S54).

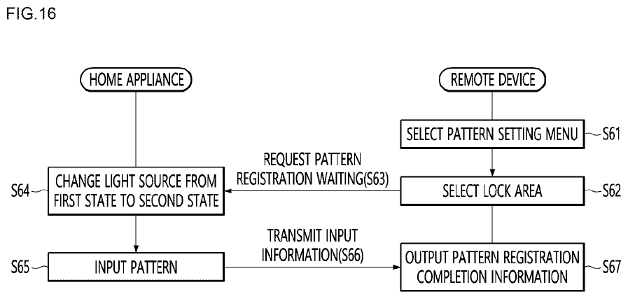

FIG. 16 is a block diagram illustrating a method for activating a lock function and registering a pattern for unlocking through a remote device according to the present disclosure.

Referring to FIG. 16, in this embodiment, it is possible to register a pattern for unlocking through interaction between the remote device 2 and a refrigerator, which is an example of a home appliance.

For example, after an application is executed on the remote device 2, a pattern setting menu may be selected from the application (S61).

When the pattern setting menu is selected on the application, a screen for selecting a lock area may be displayed on the display part of the remote device 2.

That is, when the pattern registration menu is selected through the remote device 2, a lock area for each storage space may be selected and a pattern may be registered for each lock area.

For example, a plurality of storage spaces of a refrigerator may be displayed separately on the display part, and a user may select at least one of the plurality of storage spaces.

For example, when the refrigerating compartment is selected among a plurality of storage spaces, a pattern for locking the refrigerating compartment door may be registered. When the freezing compartment is selected, a pattern for locking the freezing compartment door may be registered. That is, the pattern for locking the refrigerating compartment door may be different from the pattern for locking the freezing compartment door.

Alternatively, the refrigerating compartment and the freezing compartment may be selected at the same time. In this case, the pattern for locking the refrigerating compartment door and the freezing compartment door may be the same. That is, when a pattern for unlocking is input through one-time pattern registration, the refrigerating compartment door and the freezing compartment door can be unlocked together.

When the lock area is selected in step S62, the remote device 2 requests the refrigerator, which is a home appliance, to wait for pattern registration (S63).

Then, the refrigerator is changed to a waiting state for pattern registration. During the pattern registration process, the user may be positioned around the refrigerator.

In order to inform the user that the refrigerator 1 is in a waiting state for pattern registration, the controller 13 may control the light source of at least one door 20 to change from the first state to the second state (S64).

The user can check that input of a pattern is possible by checking the change in the state of the light source of the door 20.

The user can input a pattern into the refrigerator 1 (S65). As a method for inputting a pattern, any one of the methods described in FIG. 10, the method described in FIG. 12, and the method described in FIG. 13 may be used, so a detailed description will be omitted.

After the input of the pattern in the refrigerator 1 is completed, the refrigerator 1 transmits the input pattern information to the remote device 2 (S66). Of course, the input pattern information may also be stored in the memory 18.

At this time, the input pattern information may be transmitted to the remote device 2 via the server or directly to the remote device 2. Even when the pattern information is transmitted directly to the remote device 2, the pattern information may be transmitted to the server and stored in the server.

A method for inputting a pattern may include a method for inputting the same pattern twice. That is, after first inputting a pattern, the second input pattern is input again, and when the same pattern is input, the input pattern may be registered.

Upon receiving the pattern information input from the remote device 2, the remote device 2 may output pattern registration completion information (S67).

When pattern registration is completed, the user can check the registered pattern information on the remote device 2.

Meanwhile, the lock function may be activated or deactivated using the remote device 2.

For example, after an application is executed on the remote device 2, a lock function selection menu may be selected from the application. Next, either the lock function activation button or the lock function deactivation button may be selected.

Pattern registration is also possible in the remote device 2 itself. After the application is executed on the remote device 2, when the pattern setting menu (which may be the same or different from the pattern setting menu described in FIG. 15) is selected, a plurality of menus for selecting a pattern setting method may be displayed.

For example, a button corresponding to the button on the refrigerator described in FIG. 10 may be implemented on the display part, and a first menu for inputting a pattern using the button may be displayed.

Alternatively, in response to inputting a knock on one door described in FIG. 12, one door may be displayed on the display part, and a second menu for inputting a pattern by inputting a knock on the displayed door may be displayed.

Alternatively, in response to inputting a knock on a plurality of doors described in FIG. 13, a plurality of doors may be displayed on the display part, and a third menu for inputting a pattern by knocking on the displayed plurality of doors may be displayed.

In this way, when a pattern is registered in the remote device 2, the registered pattern information may be transmitted to the refrigerator 1 and stored in the memory 18. Then, if a pattern is input to the refrigerator 1 in the same way as the registered pattern, the door can be unlocked.

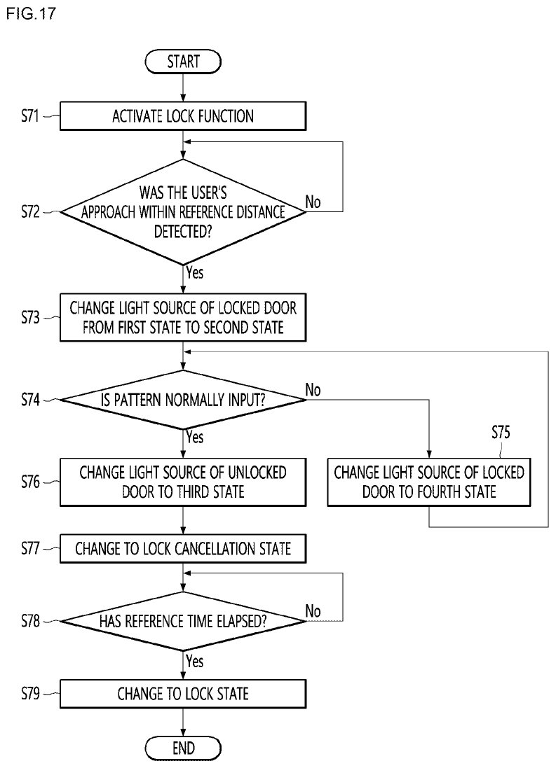

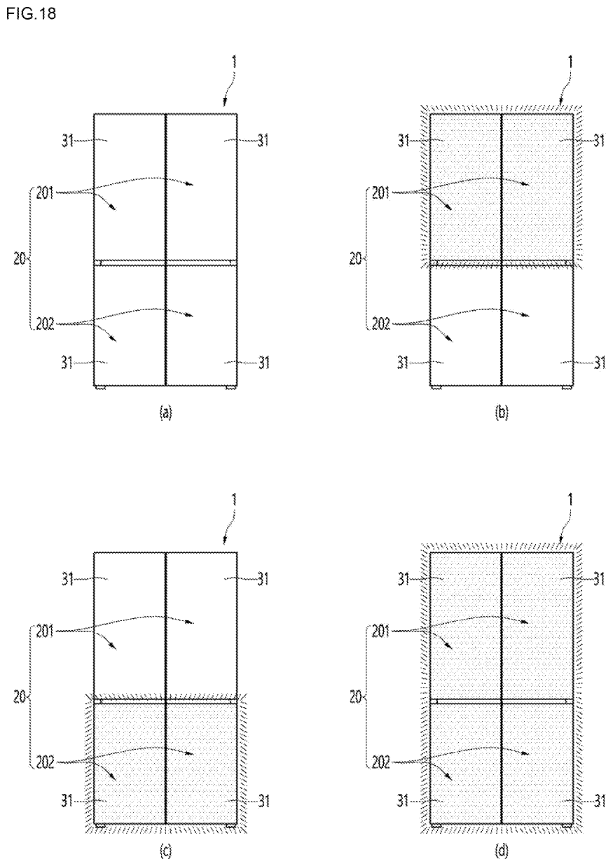

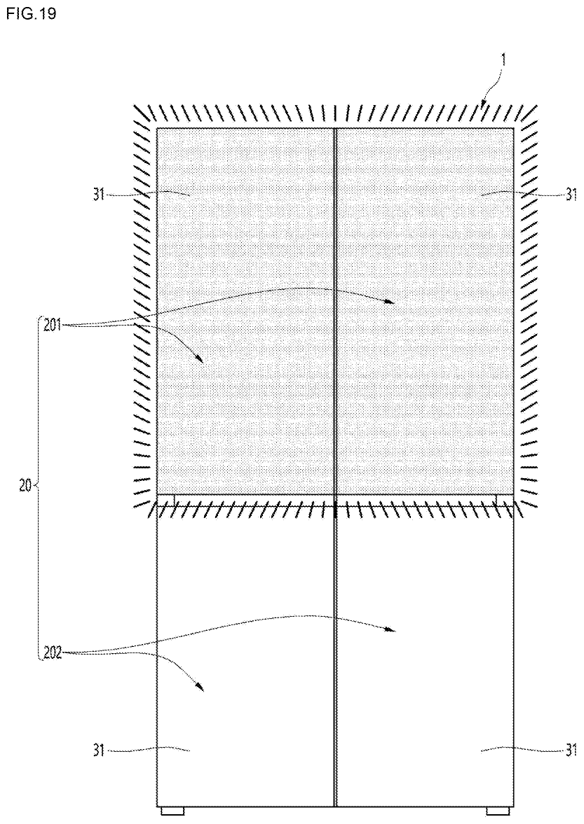

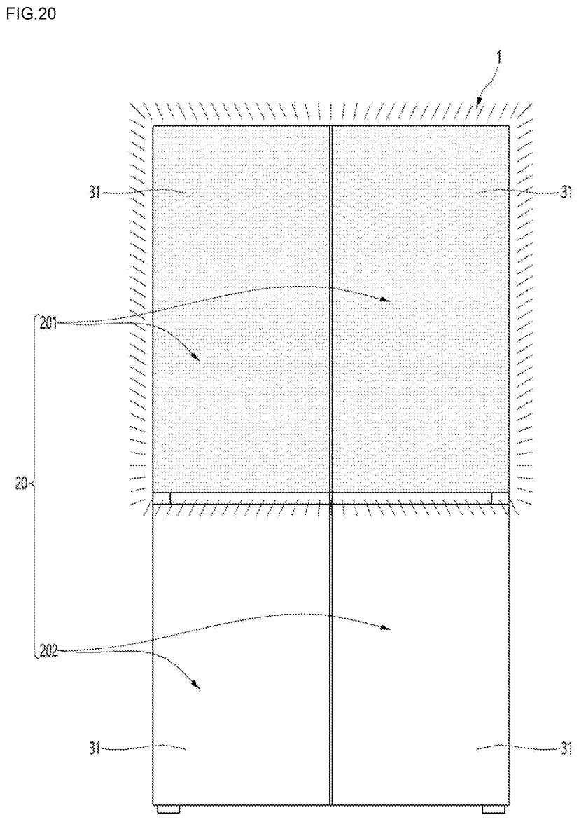

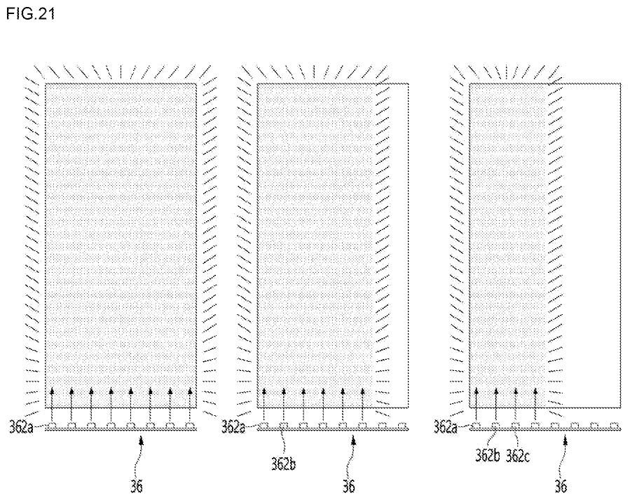

FIG. 17 is a block diagram illustrating a method for controlling a refrigerator with an activated lock function according to an embodiment of the present disclosure, FIG. 18 is a view illustrating the operation of a light source when a user's approach is detected while the lock function is activated, FIG. 19 is a view illustrating the operation of a light source when a pattern is normally input, FIG. 20 is a view illustrating the operation of a light source when a pattern is incorrectly input, and FIG. 21 is a view illustrating the operation of a light source over time after the door is unlocked.

Referring to FIGS. 17 to 21, as described above, the lock function may be activated in the refrigerator 1 according to the user's needs (S71).

When the lock function is activated, the door 20 is locked by the locking device 19.

The controller 13 may determine whether the user's approach within the reference distance is detected by the user detection sensor 151 (S72).

As a result of the determination in step S72, when it is detected that the user approaches within the reference distance, the controller 13 can cause the light source 362 of the locked door to change from the first state to the second state.

When it is not detected that the user has approached within the reference distance, for example, as illustrated in (a) of FIG. 18, the light sources 362 of all doors may maintain the first state.

When it is detected that the user approaches within the reference distance, if only the upper door 201 is in a locked state with the lock function activated, the light source 362 of the upper door 201 may be changed from the first state to the second state, as illustrated in (b) of FIG. 18.

Alternatively, if only the lower door 202 is in a locked state with the lock function activated, the light source 362 of the lower door 202 may be changed from the first state to the second state, as illustrated in (c) of FIG. 18.

Alternatively, if both the upper door 201 and the lower door 202 are in a locked state with the lock function activated, the light source 362 of each of the upper door 201 and the lower door 202 may be changed from the first state to the second state, as illustrated in (d) of FIG. 18.

Since various examples of state changes of the light source 362 have been described above, detailed descriptions will be omitted.

As another example, when it is detected that the user approaches within the reference distance, if only the upper door 201 is in a locked state with the lock function activated, the light source 362 of the upper door 201 changes from the first state to the second state, and the light source of the lower door 201 may be changed from the first state to a fifth state that is different from the second state.

Alternatively, when only the lower door 202 is in a locked state with the lock function activated, the light source 362 of the lower door 202 changes from the first state to the second state, and the light source 362 of the lower door 202 changes may be changed from the first state to the fifth state that is different from the second state.

Alternatively, when both the upper door 201 and the lower door 202 are in an unlocked state with the lock function deactivated, the light source 362 of each of the upper door 201 and the lower door 202 may be changed from the first state to the fifth state.

Although not limiting, in the second state and the fifth state, the color of light emitted from the light source 362 may be different, the brightness thereof may be different, or the number of LEDs turned on may be different.

When the refrigerator's lock function is activated and the user is detected approaching within the reference distance, if the light source 362 of the locked door changes from the first state to the second state, there is an advantage that the user easily recognizes the locked door.

If the user may check the locked door, the user may immediately open and use the unlocked door (door with the lock function deactivated), and in the case of the locked door, the user can attempt to unlock the door.

Accordingly, as the locked door cannot be opened immediately, actions such as pulling the door unnecessarily or excessively can be prevented.

In step S73, while the light source 362 of the locked door is changed from the first state to the second state, as soon as the user moves away from the refrigerator 1 by the reference distance or more, the light source 362 may be immediately changed from the second state back to the first state, or after a predetermined time has elapsed, the light source 362 may be changed from the second state back to the first state.

Meanwhile, the user may input a pattern to unlock the locked door.

The controller 13 can determine whether the pattern has been normally input (S74).

If it is determined in step S74 that the pattern was not normally input, the controller 13 may change the light source of the door in the locked state to the fourth state (S76).

Exemplarily, in the state illustrated in (b) of FIG. 18, if the pattern is not normally input (incorrectly input), the light source may be changed to the fourth state as illustrated in FIG. 20. FIG. 20 illustrates that the color of the light glowing from the door in FIG. 18(b) has changed.

Since the user generally inputs a pattern while approaching the refrigerator 1, the light source 362 may currently be in the second state, and the light source 362 may be changed from the second state to the fourth state. After the light source 362 is changed to the fourth state. when a predetermined time has elapsed, the light source 362 may be changed back to the second state.

The changing the light source 362 from the second state to the fourth state may include at least one of, for example, changing in the brightness of the light emitted from the light source 362 when the light source 362 is turned on, changing the brightness or color of the light emitted from some of the plurality of LEDs when the light source 362 is turned on, changing the number of LEDs that are turned on (increasing the number of LEDs that are turned on or decreasing the number of LEDs that are turned on), and changing the color of light emitted from the light source 362 when the light source 362 is turned on.

The user may recognize that the pattern has been incorrectly input by recognizing the change to the fourth state of the light source 362. If the user recognizes that the pattern is incorrectly input, the user may input the pattern to unlock again.

On the other hand, if it is determined in step S74 that the pattern has been normally input, the controller 13 may change the light source of the door in the locked state to the third state (S76).

The controller 13 changes the locked door to the unlocked state (S77). That is, by operating the locking device 19, the door 20 is changed to the unlocked state. Steps S76 and S76 may be performed simultaneously or sequentially, and the order may be changed.

Exemplarily, in the state illustrated in (b) of FIG. 18, if the pattern is normally input, the light source may be changed to the third state as illustrated in FIG. 19. FIG. 19 illustrates that the color of the light glowing from the door in (b) of FIG. 18 has changed.

Since the user generally inputs a pattern while approaching the refrigerator 1, the light source 362 may currently be in the second state, and the light source 362 may be changed from the second state to the third state.

For example, changing the light source 362 from the second state to the third state may include at least one of changing in the brightness of the light emitted from the light source 362 when the light source 362 is turned on, changing the brightness or color of the light emitted from some of the plurality of LEDs when the light source 362 is turned on, changing the number of LEDs that are turned on (increasing the number of LEDs that are turned on or decreasing the number of LEDs that are turned on), and changing the color of light emitted from the light source 362 when the light source 362 is turned on.

The user may check that the door is in the unlocked state by recognizing the change of the light source 362 to the third state. After the user recognizes the unlocked state of the door, the user may open the door 20.

If the refrigerator 1 includes a camera that photographs the storage space, when the door is unlocked, the camera periodically photographs the storage space, and the photographed images may be transmitted to the server. Additionally, when the door is in an unlocked state, information about the unlocked door is transmitted to the remote device 2 so that the remote device 2 may check the unlocked state of the door.

After the door 20 is changed to the unlocked state, the elapsed time is counted by the timer 16.

The controller 13 determines whether the elapsed time counted by the timer 16 elapses the reference time (S78).

When it is determined that the elapsed time has passed the reference time, the controller 13 operates the locking device 19 to change the unlocked door 20 back to the locked state (S79).

The controller 13 can change the light source of the locked door 20 from the third state to the second state and then change it to the first state. Alternatively, the controller 13 may change the light source of the locked door 20 from the third state directly to the first state.

For example, when a user's approach is detected, the light source 362 changes from an off state (first state) to an on state and the light source 362 may emit light of the first color (second state). If the pattern is normally input, the first color of the light emitted by the light source 362 may be changed to the second color (third state). Then, when the reference time has elapsed, the light source 362 may be turned off, or after the light emitted by the light source 362 changes from the second color to the first color, the light source 362 may be turned off.

Meanwhile, after the door 20 is changed to the unlocked state, information about the remaining time until the door 20 is changed to the locked state may be displayed on the door 20.

The information about the remaining time may be displayed on at least one door among the plurality of doors 20. At this time, the information about the remaining time may be displayed when the unlocked door 20 is closed.

For example, referring to (a) of FIG. 21, after the door 20 is changed to the unlocked state, all of the plurality of LEDs may be turned on.

As the on-time time elapses (or as the remaining time decreases), referring to (b) of FIG. 21, some LEDs of the turned-on LEDs may turn off, and as additional time elapses, as illustrated in (c) of FIG. 21, the number of LEDs turned on may decrease.

That is, a decrease in the number of LEDs turned on may be indirectly expressed as a decrease in remaining time. Accordingly, the user may indirectly check the remaining time by looking at the number of LEDs turned on.

Conversely, after the door 20 is changed to the unlocked state, some of the plurality of LEDs may be turned on, and as the turn-on time of the LED elapses, the number of LEDs turned on may increase (or the remaining time decreases). Accordingly, the user may indirectly check the remaining time by looking at the number of LEDs turned on.

As another example, after the door 20 is changed to the unlocked state, all of the plurality of LEDs are turned on and may emit light at the first brightness. As the turn-on time of the LED elapses (or the remaining time decreases), the brightness of the light emitted from the light source 362 may decrease or increase. The user can indirectly check the remaining time by looking at the change in brightness.

As another example, after the door 20 is changed to the unlocked state, some or all of the plurality of LEDs are turned on, and as the turn-on time of the LED elapses (or the remaining time decreases), while the number of turned on LEDs is maintained, it is also possible to change the color of the light emitted from the turned-on LED in stages.

As another example, after the door 20 is changed to the unlocked state, all of the plurality of LEDs are turned on, and as the turn-on time of the LED elapses (or the remaining time decreases), the color of the light emitted from some LEDs changes, and as the turn-on time of the LED elapses (or the remaining time decreases), the number of LEDs whose color of light changes may increase.

If the unlocked door 20 is opened while information about the remaining time is being displayed, the remaining time may not be displayed.

Additionally, when the door 20 in the unlocked state is opened and closed, when the reference time elapses, the door 20 may change to the locked state. While the door 20 is open and closed, the remaining time information may be displayed on the door 20 until the reference time elapses.

In FIG. 17, an embodiment in which steps S72 and S73 are omitted may also be derived. In this case, step S76 can be replaced by changing the light source of the unlocked door from the first state to the third state.

In describing the components of the embodiment of the present disclosure, it should be noted that the first and second terms are only used to distinguish the component from other components, and the essence, sequence, or order of the component is not limited by the terms.

Alternatively, in FIG. 17, step S75 may be replaced with a step of outputting incorrect input information from a separate sound output part.

Meanwhile, in this specification, when the state of the light source 362 is changed, when the change reference time elapses, the current state may return to the previous state or change to the different state.

For example, if the change reference time elapses after the state of the light source has been changed in steps S73, S76, and S75, the current state may return to the previous state.

Alternatively, in this specification, when the state of the light source 362 is changed and a specific event occurs, the current state may return to the previous state or change to the different state.

Meanwhile, various methods for activating the lock function have been described in FIGS. 10, 12, and 13, but as another example, in a state where the lock function is deactivated, it is also possible to activate the lock function by inputting a previously registered pattern after opening and closing the door 20 and before the input waiting time has elapsed.

1-23. (canceled)

24. A home appliance comprising:
a cabinet having a space therein;
a door configured to open and close the space, the door including a light source;
a locking device configured to restrict opening and closing of the door; and
a controller configured to:
while a lock function is activated by operation of the locking device, determine whether a pattern for unlocking the door is correctly input, and
when the controller determines that the pattern is correctly input, control the light source of the door to change the light source from a first state to a second state.

25. The home appliance of claim 24, wherein the controller is further configured to, when the controller determines that the pattern is correctly input, operate the locking device so that the door is changed to an unlocked state.

26. The home appliance of claim 25, wherein the controller is further configured to:
determine whether a reference time has elapsed after the door is changed to the unlocked state, and
operate the locking device to change the door to a locked state when the controller determines that the reference time has elapsed.

27. The home appliance of claim 26, wherein the controller is further configured to:
when the door is changed to the unlocked state and the door is closed, display information on the door indicating a remaining time until the door is changed to the locked state, or
when the door is opened and then closed after the door is changed to the unlocked state, display the information on the door indicating the remaining time until the door is changed to the locked state.

28. The home appliance of claim 24, wherein the controller is further configured to control the light source of the door to change the light source from the first state to a third state when the controller determines that the pattern is not correctly input.

29. The home appliance of claim 24, wherein the space is partitioned into a plurality of spaces,
wherein the door includes a plurality of doors configured to open and close the plurality of spaces, and
wherein the controller is configured to operate the locking device so that a door of the plurality of doors that is in a locked state is changed to an unlocked state when the controller determines that the pattern is correctly input.

30. A home appliance comprising:
a cabinet having a plurality of partitioned spaces therein;
a plurality of doors, each door configured to open and close a corresponding space of the plurality of partitioned spaces, at least a first door of the plurality of doors including a light source;
a locking device configured to restrict opening and closing of the first door;
a sensor provided on the cabinet or one of the doors of the plurality of doors to detect a proximity of a user; and
a controller configured to control the light source based on the sensor such that, when the first door is in a locked state, the light source is change from a first state to a second state when the sensor detects that the user approaches within a reference distance.

31. The home appliance of claim 30, wherein at least a second door of the plurality of doors includes a light source, and
wherein the controller is further configured to:
control the light source of the first door or the second door in an unlocked state to maintain the first state, or
control the light source of the first door or the second door in an unlocked state to change from the first state to a state different from the second state.

32. The home appliance of claim 31, wherein each door of the plurality of doors includes a light source, and
wherein the controller is further configured to control the light source of each door to change to the state different from the second state when all of the doors are in an unlocked state.

33. The home appliance of claim 31, wherein, for each of the first state and the different state, a color of light emitted from the light source is different, a brightness of the light source is different, or a number of turned on LEDs of the light source is different.

34. The home appliance of claim 30, wherein the controller is further configured to:
determine whether a pattern for unlocking the first door is correctly input, and
operate the locking device to change the first door to the unlocked state when the controller determines that the pattern is correctly input.

35. A home appliance comprising:
a cabinet having a plurality of partitioned spaces therein;
a plurality of doors, each door configured to open and close a corresponding space of the plurality of partitioned spaces;
a locking device configured to restrict opening and closing of at least one door of the plurality of doors; and
a controller configured to operate the locking device so that the at least one door is changed to a locked state when a lock function for locking the at least one door is activated.

36. The home appliance of claim 35, wherein the home appliance is configured to:
input a command for activating the lock function, or
receive the command for activating the lock function through a remote device.

37. The home appliance of claim 36, wherein the home appliance includes a manipulator including a plurality of buttons configured to input the command for activating the locking function.

38. The home appliance of claim 37, wherein the controller is further configured to, when a first button of the plurality of buttons is pressed and two or more remaining buttons of the plurality of buttons are pressed and then the first button is pressed again, determine that the command has been input, or
wherein the controller is further configured to, after the first button of the plurality of buttons is pressed and a user's proximity is detected within a limited distance by a sensor provided on the cabinet or at least one of the plurality of doors and after two or more of the remaining buttons of the plurality of buttons are pressed and then the first button is pressed again, determine that the command has been input.

39. The home appliance of claim 38, wherein the controller is further configured to, when the lock function is activated and when a same pattern as an unlocking pattern stored in a memory is input, operate the locking device so that the at least one door is changed to an unlocked state.

40. The home appliance of claim 38, wherein the at least one door of the plurality of doors includes a light source, and
wherein the controller is further configured to control the light source of the at least one door that has been changed to the unlocked state to change from a first state to a second state when a same pattern as an unlocking pattern stored in a memory is input.

41. The home appliance of claim 38, wherein the controller is further configured to:
when the first button is pressed and the first button is pressed again after a same pattern as an unlocking pattern stored in a memory is input while the locking function is activated, deactivate the locking function, or
when the first button and the second button of the plurality of buttons are pressed, a pattern identical to the unlocking pattern stored in the memory is input, a new pattern is input, and then the first button is pressed again, store the new pattern in the memory.

42. The home appliance of claim 36, further comprising:
a knock detection sensor provided on one of the plurality of doors to detect the input command for activating the locking function; and
a memory configured to store a knock pattern detected by the knock detection sensor.

43. The home appliance of claim 36, further comprising:
a knock detection sensor provided on each of two or more of the plurality of doors to detect the command for activating the lock function; and
a memory configured to store a knock pattern related to an order and number of knocks detected by the knock detection sensor of each of the two or more doors.
